(19) United States
(12) Patent Application Publication
(10) Pub. No.: US 2009/0023351 A1
(43) Pub. Date: Jan. 22, 2009

(54) FLAME-RETARDANT RESIN COMPOSITION, PREPREG, RESIN SHEET, AND MOLDING

(76) Inventors: Keiko Kashihara, Ibaraki-shi (JP); Kenji Ogasawara, Hirakata-shi (JP)

Correspondence Address: Cheng Law Group, PLLC, 1100 17th Street, N.W., Suite 503, Washington, DC, 20036, US

(21) Appl. No.: 12/279,979

(22) PCT Filed: Feb. 21, 2006
(86) PCT No.: PCT/JP2006/303020

§ 371 Date: Aug. 19, 2008

(51) Int. Cl. B32B 27/04; C07F 9/141

(52) U.S. Cl. 442/142; 524/148; 428/422.8

(57) ABSTRACT

Provided is a flame-retardant resin composition that keeps flame-retardancy certainly without containing any halogen compound, which may cause the generation of a harmful material, and can simultaneously maintain the original property of the resin at a high level.

The invention relates to a flame-retardant resin composition. The composition contains a resin containing any one or both of a thermosetting resin and a thermoplastic resin, and a cyclophosphazene represented by the following formula (1) wherein the cyclophosphazene compound is incorporated into the resin in an amount of 0.1 to 200 parts by mass based on 100 parts by mass of the resin:

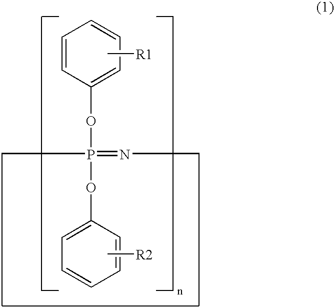

wherein n=3 to 25, one of R1 and R2 is CN, and the other is H, or both thereof are CN, and the percentage of the cyanophenoxy groups in the compound is from 2 to 98% of the total number of the phenoxy groups and the cyanophenoxy groups in the compound.

### TECHNICAL FIELD

The present invention relates to a flame-retardant resin composition used to produce a printed wiring board or seal (or encapsulate) a semiconductor element; a prepreg and a resin sheet which can each be produced by use of this flame-retardant resin composition; and a molding such as a printed wiring board or a molding obtained by sealing a semiconductor element.

### BACKGROUND ART

Moldings such as a printed wiring board, or moldings obtained by sealing a semiconductor element require flame-retardant in order to ensure the safety thereof. To make the products flame-retardant can be attained by use of a resin composition which contains a halogen compound. In recent years, however, it has been pointed out as a problem that these moldings each made of the resin composition generate harmful dioxins when the products are incinerated.

Thus, instead of using any halogen compound, a compound made mainly of nitrogen or phosphorus is incorporated, as a flame retardant, into a resin composition, thereby making the composition flame-retardant (see, for example, Patent Documents 1 to 3).

Patent Document 1: JP-A-10-259292

Patent Document 2: JP-A-11-181429

Patent Document 3: JP-A-2002-114981

### DISCLOSURE OF THE INVENTION

### Problems to be Solved by the Invention

However, the flame-retardant-containing resin compositions described in Patent Documents 1 to 3 are each a compatible system; therefore, after the composition is formed into a shape, the original property of the resin may be damaged by the flame retardant. Specifically, by use of the flame retardant, the glass transition temperature (Tg) of the resin is lowered so that the heat resistance of the molding may be damaged.

In light of the above-mentioned points, the invention has been made. An object of the invention is to provide a flame-retardant resin composition, a prepreg, a resin sheet and a molding which keep flame-retardancy certainly without containing any halogen compound, which may cause the generation of a harmful material, and can simultaneously maintain the original property of the resin at a high level.

### Means for Solving the Problems

A flame-retardant resin composition of the invention according to claim 1, wherein the composition includes a resin including any one or both of a thermosetting resin and a thermoplastic resin, and a cyclophosphazene represented by the following formula (1), wherein the cyclophosphazene compound is incorporated into the resin in an amount of 0.1 to 200 parts by mass based on 100 parts by mass of the resin:

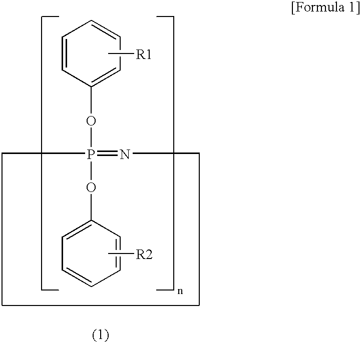

wherein n=3 to 25, one of R1 and R2 is CN, and the other is H, or both thereof are CN, and the percentage of the cyanophenoxy groups in the compound is from 2 to 98% of the total number of the phenoxy groups and the cyanophenoxy groups in the compound.

The invention according to claim 2, wherein the composition includes an inorganic filler in claim 1.

The invention according to claim 3, wherein the composition includes one or more resins selected from the thermosetting resins consisting of a group of-epoxy resin, radical polymerizable resin, polyimide resin, and modified resins thereof; and thermoplastic resins consisting of a group of polyphenylene ether resin, thermoplastic polyimide resin, polyetherimide resin, poyethersulfone resin, phenoxy resin, and modified resins thereof.

A prepreg of the invention according to claim 4, wherein the prepreg is obtained by impregnating a glass substrate or an organic fiber substrate with the flame-retardant resin composition as recited in any one of claims 1 to 3, and then drying the resultant.

A resin sheet of the invention according to claim 5, wherein the resin sheet is obtained by applying the flame-retardant resin composition as recited in any one of claims 1 to 3 on a metal foil surface or a film surface, and then drying the resultant.

A molding of the invention according to claim 6, wherein the molding is obtained by forming the flame-retardant resin composition as recited in any one of claims 1 to 3 into a shape.

### Effect of the Invention

According to the flame-retardant resin composition of the invention of claim 1, provided is a composition which can keep flame retardancy certainly by effect of the given cyclophosphazene compound while maintaining the original property of the resin at a high level without containing any halogen compound, which may cause the generation of a harmful material.

According to the invention of claim 2, a molding having an improved strength and a further improved flame retardancy can be given.

According to the invention of claim 3, the Tg is made higher compared with the use of any other resin, so that a high heat resistance can be obtained.

According to the prepreg of the invention of claim 4, provided is a prepreg which can keep flame retardancy certainly by effect of the given cyclophosphazene compound while maintaining the original property of the resin at a high level without containing any halogen compound, which may cause the generation of a harmful material.

According to the resin sheet of the invention of claim 5, provided is a resin sheet which can keep flame retardancy certainly by effect of the given cyclophosphazene compound while maintaining the original property of the resin at a high level without containing any halogen compound, which may cause the generation of a harmful material.

According to the molding of the invention of claim 6, provided is a molding which can keep flame retardancy certainly by effect of the given cyclophosphazene compound while maintaining the original property of the resin at a high level without containing any halogen compound, which may cause the generation of a harmful material.

### BEST MODE FOR CARRYING OUT THE INVENTION

Embodiments of the invention will be described hereinafter.

The flame-retardant resin composition according to the invention can be produced by incorporating 0.1 to 200 parts by mass of a cyclophosphazene represented by a formula (1) illustrated below (hereinafter appropriately referred to as a “cyclophosphazene compound of the formula (1)”) based on 100 parts by mass of a resin including any one or both of a thermosetting resin and a thermoplastic resin. In the invention, the cyclophosphazene compound of the formula (1) is used as a flame retardant. This cyclophosphazene compound of the formula (1) may be a cyclophosphazene compound synthesized by the method described in Patent Document 3 (JP-A-2002-114981) described above. If the amount of the cyclophosphazene compound of the formula (1) is less than 0.1 part by mass based on 100 parts by mass of the resin, a sufficient flame retardancy cannot be certainly kept. Conversely, if the amount is more than 200 parts by mass, the amount of the resin is relatively small so that the composition cannot be formed into a shape. As far as the advantageous effect based on the cyclophosphazene compound of the formula (1) is not damaged, aluminum hydroxide, silicon dioxide (SiO₂) or the like may be used in combination.

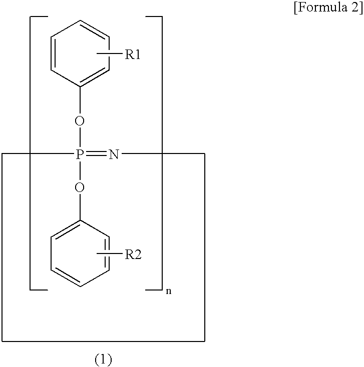

wherein n=3 to 25, one of R1 and R2 is CN, and the other is H, or both thereof are CN, and the percentage of the cyanophenoxy groups in the compound is from 2 to 98% of the total number of the phenoxy groups and the cyanophenoxy groups in the compound.

The cyanophenoxy group is a functional group represented by a formula (2) illustrated below, and the phenoxy group is a functional group represented by a formula (3) illustrated below. If the percentage of the cyanophenoxy groups in the cyclophosphazene compound of the formula (1) is less than 2% or is reversely more than 98%, a high flame retardancy and a high glass transition temperature (Tg) cannot be made consistent with each other.

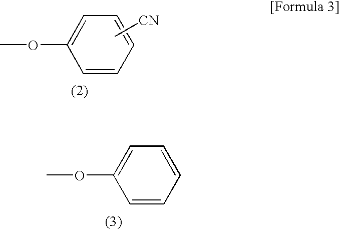

Specific examples of the cyclophosphazene compound of the formula (1) include as follows:

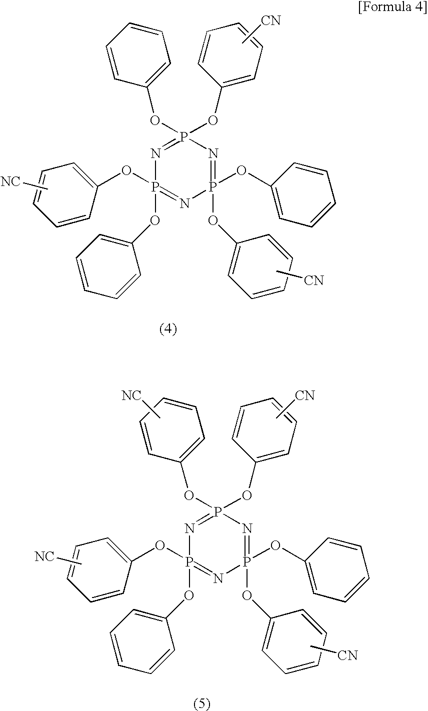

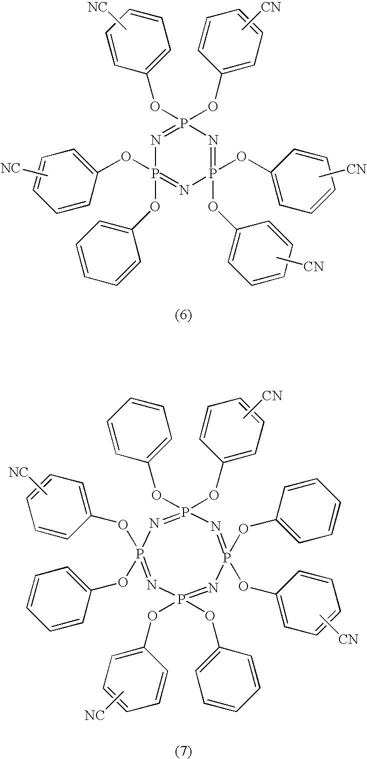

The percentage of the cyanophenoxy groups can be calculated out by substituting the mole numbers of cyanophenol and phenol charged when the cyclophosphazene compound of the formula (1) is synthesized for the following equation:

Percentage (%) of the cyanophenoxy groups=(mole number of cyanophenol)/(mole number of cyanophenol+mole number of phenol)×100

For reference, in a cyclophosphazene compound represented by a formula (8) illustrated below, no phenoxy group is present and groups or atoms bonded to the P atom are only cyanophenoxy groups except N atoms. For this reason, the percentage of the cyanophenoxy groups is 100%. Thus, a sufficient flame retardancy cannot be certainly kept as described above.

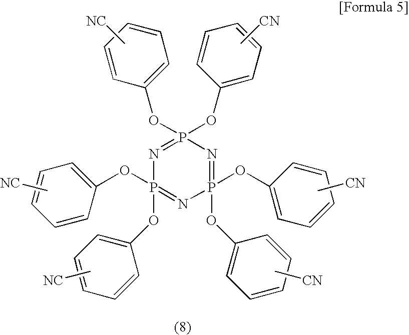

Examples of the thermosetting resin that may be used include such as modified polyphenylene ether resin (PPE), polyfunctional epoxy resin, o-cresol novolak epoxy resin, bisphenol A (Bis-A) epoxy resin, triallylisocyanurate resin (TAIC), and bismaleimide resin. In order to make the Tg high and to make the heat resistance higher, it is preferred to select one or more from the group of epoxy resin, radical polymerizable resin, polyimide resin, and modified resins thereof, and use. Specific examples of the epoxy resin include such as polyfunctional epoxy resins of triphenylmethane type or the like, o-cresol novolak epoxy resin, and bisphenol A (Bis-A) epoxy resin. Specific examples of the radical polymerizable resin include such as methacrylates or acrylates of the above-mentioned epoxy resins, acrylic acid esters, and triallylisocyanurate resin (TAIC). Specific examples of the polyimide resin include such as bismaleimide resin.

Examples of the thermoplastic resin include such as OH-modified polyphenylene ether resin (PPE), phenoxy resin, polyethersulfone resin (PES), polyphenylene ether resin (PPE), polyimide resin, and styrene based polymer (SPS) having a syndiotactic structure. In order to make the Tg high and to make the heat resistance higher, it is preferred to select one or more from the group of polyphenylene ether resin (PPE), thermoplastic polyimide resin, polyetherimide resin, polyethersulfone resin (PES), phenoxy resin, and modified resins thereof, and use. Specific examples of the polyphenylene ether resin (PPE) include such as OH-modified polyphenylene ether resin (PPE).

A curing agent or a catalyst may be incorporated into the flame-retardant resin composition according to the invention. Examples of the curing agent or catalyst that may be used include such as dicyandiamide (DICY), phenol novolak, diaminodiphenylmethane (DDM), 2-ethyl-4-methylimidazole (2E4MZ), cumene hydroperoxide (CHP), a,a′-bis(t-butylperoxy-m-isopropyl)benzene, and triphenylphosphine.

The flame-retardant resin composition according to the invention may contain an inorganic filler in order to enhance the strength of the molding and further enhance the flame retardancy. Examples of the inorganic filler that may be used include such as titania (TiO₂), and calcium carbonate (CaCO₃). Such an inorganic filler may be incorporated in an amount of 0.1 to 200 parts by mass based on 100 parts by mass of the resin including any one or both of a thermosetting resin and a thermoplastic resin. The flame-retardant resin composition according to the invention may contain, besides the inorganic filler, “CTBN” manufactured by Ube Industries, Ltd., which is a liquid polybutadiene rubber having a modified carboxyl terminal, a coupling agent such as

γ-glycidoxypropyltriethoxysilane, a releasing agent such as carnauba wax, and the like.

The flame-retardant resin composition according to the invention can be produced by incorporating a cyclophosphazene compound of the formula (1) in an amount of 0.1 to 200 parts by mass based on 100 parts by mass of the resin including any one or both of a thermosetting resin and a thermoplastic resin, and optionally incorporating an inorganic filler and the like.

The prepreg according to the invention can be produced as follows: First, the above-mentioned flame-retardant resin composition is dissolved in a solvent such as dimethylacetoamide, dimethylformamide (DMF), N-methylpyrrolidone, dimethylsulfoxide, methyl ethyl ketone (MEK), cyclohexanone, toluene or xylene, thereby preparing a vanish. Next, a glass substrate or an organic fiber substrate made of such as aramide fiber, polyester fiber, polyimide fiber, polyacryl fiber is impregnated with the thus-obtained varnish. Thereafter, this is dried to be a semi-cured B stage state. In this way, the prepreg according to the invention can be produced. The thus-obtained prepreg may be used as a material of a printed wiring board.

The resin sheet according to the invention can be produced as follows: the sheet can be produced by applying a vanish obtained as described above onto a metal foil surface or film surface, and then drying the resultant to be a semi-cured B stage state. The thus-obtained resin sheet may also be used as a material of a printed wiring board.

The resin sheet according to the invention is a sheet obtained as a metal-foil-attached resin sheet in a case of applying the vanish to a metal foil. The resin sheet is a sheet obtained as a film-attached resin sheet in a case of applying the vanish to a film. The metal foil that may be used is, for example, copper foil or aluminum foil, and the film that may be used is, for example, a fluorine-contained resin film or a PET film.

The molding according to the invention can be obtained by forming the flame-retardant resin composition into a shape. For example, when the flame-retardant resin composition is used as a sealing (or encapsulating) material and this is used to seal and mold a semiconductor element, a semiconductor device can be obtained as a molding.

Since the flame-retardant resin composition according to the invention is not a compatible system but an incompatible system, the original property of the resin is not damaged by the cyclophosphazene compound of the formula (1) after the composition is formed into a shape. Specifically, the use of the cyclophosphazene compound of the formula (1) makes it possible to prevent a fall in the Tg of the thermosetting resin or the thermoplastic resin and heighten the heat resistance of a molding obtained by forming the flame-retardant resin composition into a shape. Since the molding does not have any halogen compound at all, harmful materials such as dioxins are not generated even if the molding is incinerated. Thus, a nonpoisonous molding can be obtained.

### EXAMPLES

The invention will be specifically described by way of the following examples.

### (Thermoplastic Resins)

As thermoplastic resins, OH-modified PPE-1; OH-modified PPE-2; a phenoxy resin (“PKFE”, manufactured by Inchem); a PES (“POLYETHERSULFONE 5003P”, manufactured by Sumitomo Chemical Co., Ltd.); a PPE (“640-111”, manufactured by Nippon G.E. Plastic Kabushiki Kaisha [transliteration]); a polyimide resin (“ULTEM [transliteration]”, manufactured by Nippon G.E. Plastic Kabushiki Kaisha); and an SPS (“33EX003”, manufactured by Idemitsu Petrochemical Co., Ltd.) were used.

OH-modified PPE-1 described above was prepared as follows: that is, to 100 parts by mass of toluene were added 100 parts by mass of “640-111” (number-average molecular weight Mn=20000) manufactured by Nippon G.E. Plastic Kabushiki Kaisha, which is a polymer PPE, 5 parts by mass of benzoyl peroxide, and 6 parts by mass of bisphenol A. This was stirred at 60° C. for 90 minutes to conduct redistribution reaction, thereby yielding a solution of OH-modified PPE-1. The molecular weight distribution of OH-modified PPE-1 in this solution was measured by gel permeation chromatography (column structure: “SuperHM-M” (single column)+“SuperHM-H” (single column) manufactured by Tosoh Corp.). As a result, it was confirmed that the number-average molecular weight of OH-modified PPE-1 was 2300.

OH-modified PPE-2 described above was prepared in the same way as OH-modified PPE-1 except that 3 parts by mass of bisphenol A was added. The molecular weight distribution of OH-modified PPE-2 was measured in the same way as that of OH-modified PPE-1. As a result, it was turned out that the number-average molecular weight of OH-modified PPE-2 was 4000.

### (Thermosetting Resins)

As thermosetting resins, a modified PPE; a polyfunctional epoxy resin (“EPPN501H”, manufactured by Nippon Kayaku Co., Ltd.; an o-cresol novolak epoxy resin (“EOCN195XL4”, manufactured by Sumitomo Chemical Co., Ltd.); a Bis-A methacrylate resin; a TAIC (manufactured by Nippon Kasei Chemical Co., Ltd.); and a bismaleimide resin (“BMI-S”, manufactured by Daiwa Kasei K.K.) were used.

The modified PPE was prepared as follows: first, mixed were 36 parts by mass of “NOLYL [transliteration] PX9701” (number-average molecular weight Mn=14000) manufactured by Nippon G.E. Plastic Kabushiki Kaisha, which is a PPE, 0.77 part by mass of 2,6-xylenol, which is a kind of phenol, 1.06 parts by mass of t-butylperoxyisopropylmonocarbonate (“PERBUTYL I”, manufactured by NOF Corp.) as an initiator, and 0.0015 part by mass of cobalt naphthenate. 90 parts by mass of toluene was added thereto as a solvent. The components were mixed with each other at 80° C. for 1 hour to disperse and dissolve the components and cause the reaction. In this way, a PPE solution was obtained. The molecular weight distribution of the PPE in this solution was measured by gel permeation chromatography (column structure: “SuperHM-M” (single column)+“SuperHM-H” (single column) manufactured by Tosoh Corp.). As a result, it was confirmed that the number-average molecular weight of the PPE was about 3500. The PPE solution was dried at 70° C. under reduced pressure to remove toluene as a solvent until the concentration thereof to be 1% or less by mass. Next, allyl groups (CH₂═CH—CH₂—), which are each an unsaturated group of carbon-carbon, were introduced into the molecules of the PPE, the molecular weight of which was lowered as described above. Specifically, the PPE was weighed out in an amount of 350 g. This was dissolved in 7 liters of tetrahydrofuran, and further thereto was added 390 mL of a solution of n-butyllithium in hexane (1.5 moles/liter). The resultant solution was stirred at 40° C. for 1 hour to cause the reaction. To this reactant was added 30 mL of allylbromide, and further the solution was stirred for 30 minutes while the temperature was kept at 40° C. To this solution was added a mixed solvent of 3 L of water and 3 L of methanol to precipitate a polymer. Filtration and washing with methanol were repeated 5 times. Thereafter, the resultant was vacuum-dried at 50° C. for 24 hours to yield a modified PPE as an allyl-group-containing PPE.

The Bis-A methacrylate resin was prepared as follows: Into a four-necked flask were charged 136 g of “YD-128” (epoxy equivalent: 190) manufactured by Tohto Kasei Co., Ltd. as an epoxy resin, 0.4 g of triphenylphosphine, 0.06 g of hydroquinone, and 0.21 g of methacrylic acid. Thereafter, the reactive components were caused to react at 120° C. until the acid value turned to 10.0 or less. Next, thereto were charged 90 g of styrene and 12 g of acrylic acid, so as to yield the BiS-A methacrylate resin as a radical polymerizable resin.

### (Flame Retardants)

As flame retardants, the following were used: incompatible type phosphazenes 1 to 5 having cyanophenoxy groups; a compatible type phosphazene (“SPB100”, manufactured by Ohtsuka Chemical Industrial Co., Ltd.); aluminum hydroxide; and silicon oxide (SiO₂).

Incompatible type phosphazenes 1 to 5 having cyanophenoxy groups (corresponding to Synthesis Examples 1 to 5 in Table 1 described below, respectively) were synthesized as follows: To a four-necked flask having a volume of 2 liters and equipped with a stirrer, a heater, a thermometer and a dehydrator were added 1.76 moles of 4-cyanophenol, 0.88 mole of phenol, 2.64 moles of sodium hydroxide, and 1000 mL of toluene. Next, this mixture was heated and refluxed to remove water from the system to prepare a toluene solution containing a sodium salt of cyanophenol and a sodium salt of phenol. To this toluene solution of the sodium salts of cyanophenol and phenol was dropwise added 580 g of a 20% solution containing one mole of dichlorophosphazene oligomer 1 (containing trimers in an amount of 95% or more) in chlorobenzene at an internal temperature of 30° C. or lower while the former solution was stirred. This mixed solution was refluxed for 12 hours, and then a 5% sodium hydroxide solution in water was added to the reaction mixture so as to wash the mixture two times. Next, the organic phase was neutralized with diluted sulfuric acid, and then washed with water 2 times. The organic phase was filtrated, concentrated, and vacuum-dried (conditions for the vacuum-drying: 80° C. and 5 mmHg for 12 hours), thereby yielding incompatible type phosphazene 1 having cyanophenoxy groups (Synthesis Example 1). This was identified as “N=P(OC₆H₄CN)_{1.34}(OC₆H₅)_{0.66}” by elementary analysis.

Incompatible type phosphazene 2 containing cyanophenoxy groups (Synthesis Example 2) was synthesized in the same way as in Synthesis Example 1 except that instead of dichlorophosphazene oligomer 1, dichlorophosphazene oligomer 2 (containing trimers in an amount of 85% or more and containing the trimers and tetramers in a total amount of 95% or more) was used.

Incompatible type phosphazenes 3 to 5 containing cyanophenoxy groups (Synthesis Examples 3 to 5) were each synthesized in the same way as in Synthesis Example 1 except that the mole number of 4-cyanophenol and that of phenol were changed as shown in Table 1 described below.

TABLE 1

| | Synthesis | Synthesis | Synthesis | Synthesis | Synthesis |
|---|---|---|---|---|---|
| | Example 1 | Example 2 | Example 3 | Example 4 | Example 5 |
| Dichlorophosphazene oligomer 1 (*) | 115.9 (1) | 0 | 115.9 (1) | 115.9 (1) | 115.9 (1) |
| mass (mole(s)) | | | | | |
| Dichlorophosphazene oligomer 2 (#) | 0 | 115.9 (1) | 0 | 0 | 0 |
| mass (mole(s)) | | | | | |
| 4-Cyanophenol mass (moles) | 209.6 (1.76) | 209.6 (1.76) | 157.2 (1.32) | 262 (2.2) | 314.4 (2.64) |
| Phenol mass (mole(s)) | 82.8 (0.88) | 82.8 (0.88) | 124.2 (1.32) | 52.4 (0.44) | 0 |
| Percentage of cyanophenol groups | 67% | 67% | 50% | 83% | 100% |

(*) Oligomer containing trimers in an amount of 95% or more
(#) Oligomer containing trimers in an amount of 85% or more and the trimers and tetramers in a total amount of 95% or more)

### (Curing Agents/Catalysts)

As curing agents or catalysts, dicyandiamide (DICY); a phenol novolak (“H-4”, manufactured by Meiwa Chemical Industry Co., Ltd.); diaminodiphenylmethane (manufactured by Sumitomo Chemical Co., Ltd.); 2-ethyl-4-methylimidazole (2E4MZ) (manufactured by Shikoku Chemicals Corp.); cumene hydroperoxide (CHP) (“PERCUMIL [transliteration] H-80”, manufactured by NOF Corp.);

a,a′bis(t-butylperoxy-m-isopropyl)benzene (“PERBUTYL P”, manufactured by NOF Corp.); and triphenylphosphine (reagent manufactured by Wako Pure Chemical Industries, Ltd.) were used.

### (Other Additives)

As other additives, CTBN (“Highcker [transliteration] CTBN 1300×13”, manufactured by Ube Industries, Ltd.); γ-glycidoxypropyltriethoxysilane; carnauba wax; titania; and calcium carbonate were used.

### (Varnishes)

With respect to each of Examples 1 to 5 and 13 to 19, and Comparative Examples 1 to 4 and 9 to 11, individual components were blended in blend amounts (part(s) by mass) shown in Table 2, 4, 5, 6, 7, or 8 described below. The resultant was diluted with toluene to be the solid content in percentage of 50% by mass, thereby yielding a vanish for impregnation.

With respect to each of Example 6 and Comparative Example 5, individual components were blended in blend amounts (part(s) by mass) shown in Table 2 or 6 described below. The resultant was diluted with a mixed solvent of DMF/MEK/methoxypropanol (ratio by mass=23/12/15) to be the solid content in percentage of 50% by mass, thereby yielding a vanish for impregnation.

With respect to Example 7, individual components were blended in blend amounts (part(s) by mass) shown in Table 2 described below. The resultant was diluted with MEK to be the solid content in percentage of 50% by mass, thereby yielding a vanish for impregnation.

With respect to each of Examples 8 and 9 and Comparative Example 6, individual components were blended in blend amounts (part(s) by mass) shown in Table 3 or 7 described below. The resultant was diluted with styrene monomers to be the solid content in percentage of 70% by mass, thereby yielding a vanish for impregnation.

With respect to each of Example 10 and Comparative Example 7, individual components were blended in blend amounts (part(s) by mass) shown in Table 3 or 7 described below. The resultant was diluted with DMF to be the solid content in percentage of50% by mass, thereby yielding a vanish for impregnation.

With respect to each of Examples 11 and 12 and Comparative Example 8, individual components were blended in blend amounts (part(s) by mass) shown in Table 3 or 7 described below. The resultant was diluted with a mixed solvent of

DMF/MEK/methoxypropanol (ratio by mass=23/12/15) to be the solid content in percentage of 50% by mass, thereby yielding a vanish for impregnation.

With respect to each of Example 20 and Comparative Example 12, individual components were blended in blend amounts (part(s) by mass) shown in Table 5 or 8 described below. The resultant was diluted with a mixed solvent of

DMF/cyclohexanone/MEK (ratio by mass=20/80/25) to be the solid content in percentage of 40% by mass, thereby yielding a vanish for impregnation.

A “HOMODISPER” manufactured by PRIMIX Corp. was used to stir the varnishes for impregnation and painting at about 1000 rpm for about 90 minutes. The above-mentioned solid contents mean each the amount of any component other than the solvent.

### (Evaluating Samples)

With respect to each of Examples 1 to 7, 9, 10 and 13 to 20, and Comparative Examples 1, 2, 4, 5, 7 and 9 to 12, a laminated plate (CCL) was produced as an evaluating sample. Specifically, a glass cloth (individual weight: 107 g/m², and thickness: 0.1 mm) was impregnated with each of the varnishes for impregnation, and the resultant was dried to produce prepregs (resin amount: 40% by mass). Eight out of the prepregs were put onto each other, and further a copper foil piece having a thickness of 18 μm was put onto each of the front and rear surfaces thereof. This was heated and pressed under curing conditions that the temperature was 200° C., the pressure was 3 MPa and the period was 120 minutes, so as to perform lamination molding, thereby producing a double-sided copper-clad laminated plate (CCL). With respect to Comparative Example 3, no evaluating sample was able to be produced.

With respect to each of Example 8 and Comparative Example 6, a composite laminated plate (CEM3) was produced as an evaluating sample. Specifically, plain woven glass clothes (thickness: 200 μm, and size: 300 mm×300 mm) and glass paper pieces (individual weight: 51 g/m², density: 0.14 g/cm³, and size: 300 mm×300 mm) were impregnated with each of the vanishes for impregnation to obtain plain woven glass cloth impregnation-products and glass paper piece impregnation-products. Next, two out of the glass paper piece impregnation-products were put onto each other, and then one out of the plain woven glass cloth impregnation-products was put and laminated onto each side of the resultant so as to give a sandwich structure. Furthermore, one copper foil piece having a thickness of 18 μm was put onto each side of the resultant to yield a laminate. This laminate was sandwiched between metal plates, and the resultant workpiece was subjected to lamination molding under curing conditions that the temperature was 110° C. and the period was 30 minutes. Thereafter, the workpiece was after-cured under conditions that the temperature was 180° C. and the period was 30 minutes to produce a composite copper-clad laminated plate having a thickness of 1.6 mm.

With respect to each of Example 11 and Comparative Example 8, a resin sheet covered with copper foil (RCC) was produced as an evaluating sample. Specifically, each of the varnishes for painting was painted onto a roughed surface of a copper foil piece (“GT”, manufactured by Furukawa Circuit Foil Co., Ltd.) having a thickness of 0.018 mm with a comma coater at room temperature. This was heated at about 160° C. by means of a noncontact type heating unit to remove the meltable agent in the vanish and further dry the workpiece into a semi-cured B stage state, thereby producing a resin sheet covered with the copper foil (RCC) having a resin layer of 80 μm thickness.

With respect to Example 12, a film-covered resin sheet was produced as an evaluating sample. Specifically, a comma coater was used to apply the vanish for applying to a surface of a PET film having a thickness of 40 μm to be a thickness of about 60 μm. While this workpiece was carried at a carrying speed of 20 cm/minute, the workpiece was heated at a temperature of 100° C. so as to be dried into a semi-cured B stage state. Furthermore, in order to protect the vanish-painted surface, a polyethylene film 20 μm in thickness was used as a cover film and the vanish-painted surface was covered with this film to produce a film-covered resin sheet (thickness of its resin layer: 30 μm).

With respect to each of Example 21 and Comparative Example 13, individual components were blended in blend amounts (part(s) by mass) shown in Table 5 or 8 described below to produce a flame-retardant resin composition usable as a sealing material. Next, this composition was heated at 175° C. for 90 seconds to be cured, and further the composition was after-cured at 175° C. for 6 hours to produce an evaluating sample (test piece).

With respect to each of Example 22 and Comparative Example 14, individual components were blended in blend amounts (part(s) by mass) shown in Table 5 or 8 described below. This blend product was melted and kneaded by means of a heating roll in a temperature from 85 to 95° C., so as to produce a molding material. This molding material was subjected to injection molding to produce an evaluating sample (test piece).

### (Frame Retardancy (FR Property))

With respect to each of Examples 1 to 10 and 13 to 22, and Comparative Examples 1, 2, 4 to 7 and 9 to 14, a test piece 125 mm long and 13 mm wide was cut away from the evaluating sample (the CCL, the CEM3, or the test piece). With respect to this test piece, a burning behavior test was made in accordance with “Test for Flammability of Plastic Materials-UL 94”, of Underwrites laboratories.

With respect to each of Example 11 and Comparative Example 8, from a copper-clad laminate plate “R1566” (substrate thickness: 0.8 mm, and copper foil piece thickness: 18 μm) manufactured by Matsushita Electric Works, Ltd., the copper foil was removed by etching, so as to produce a core material. The RCC which was the evaluating sample was put onto each of the surfaces of this core material in such a manner that the resin side of the RCC was brought into contact with the core material. The resultant was pressed, and then cured. Next, the outside copper foil pieces were removed from this cured product by etching, and then a test piece 125 mm long and 13 mm wide was cut away therefrom. With respect to this test piece, a burning behavior test was made in accordance with “Test for Flammability of Plastic Materials-UL 94” of Underwrites laboratories.

With respect to Example 12, from a copper-clad laminate plate “R1566” (substrate thickness: 0.8 mm, and copper foil piece thickness: 18 μm) manufactured by Matsushita Electric Works, Ltd., the copper foil was removed by etching, so as to produce a core material. The film which was the evaluating sample was put onto each of the surfaces of this core material. A vacuum laminator manufactured by Meiki Co., Ltd. was used to laminate the film onto the core material, and then the resultant was cured. Next, a test piece 125 mm long and 13 mm wide was cut away from this cured product. With respect to this test piece, a burning behavior test was made in accordance with “Test for Flammability of Plastic Materials-UL 94” of Underwrites laboratories.

### (Glass Transition Temperature (Tg))

About each of the evaluating samples of Examples 1 to 10 and 13 to 22, and Comparative Examples 1, 2,4 to 7 and 9 to 14, a viscoelastic spectrometer “DMS100” manufactured by Seiko Instruments Ltd. was used to measure the glass transition temperature (Tg). At this time, the measurement was set to be the frequency in a bending module to 10 Hz. When the temperature was raised from room temperature to 280° C. under the condition that the temperature-raising rate was 5° C./min., the temperature at which the tanδ showed a maximum value was defined as the glass transition temperature (Tg).

With respect to each of the evaluating samples of Examples 11 and 12, and Comparative Example 8, a viscoelastic spectrometer “DMS200” manufactured by Seiko Instruments Ltd. was used to measure the glass transition temperature (Tg). At this time, the measurement was made to set the frequency in a tensile module to 10 Hz. When the temperature was raised from room temperature to 280° C. under the condition that the temperature-raising rate was 5° C./min., the temperature at which the tans showed a maximum value was defined as the glass transition temperature (Tg).

The results of the flame retardancy (FR property) and the measured results of the glass transition temperature (Tg) are shown in Tables 2 to 8 described below.

TABLE 2

| | | Example 1 | Example 2 | Example 3 | Example 4 | Example 5 | Example 6 | Example 7 |
|---|---|---|---|---|---|---|---|---|
| Thermoplastic resin | OH-modified PPE-1 | 40 | 40 | 40 | 40 | 40 | | |
| | OH-modified PPE-2 | | | | | | | |
| | Phenoxy resin | | | | | | | |
| | PES | | | | | | | |
| | PPE | | | | | | | |
| | Polyimide resin | | | | | | | |
| | SPS | | | | | | | |
| Thermosetting resin | Modified PPE | | | | | | | |
| | Polyfunctional epoxy resin | 58 | 58 | 58 | 58 | 58 | 94 | 63 |
| | o-Cresol novolak epoxy resin | | | | | | | |
| | Bis-A methacrylate | | | | | | | |
| | TAIC | | | | | | | |
| | Bismaleimide | | | | | | | |
| Curing agent/catalyst | DICY | | | | | | 6 | |
| | Phenol novolak | | | | | | | 37 |
| | DDM | 1 | 1 | 1 | 1 | 1 | | |
| | 2E4MZ | 0.1 | 0.1 | 0.1 | 0.1 | 0.1 | 0.1 | 0.1 |
| | CHP | | | | | | | |
| | PERBUTYL P | | | | | | | |
| | Triphenylphosphine | | | | | | | |
| Others | CTBN | | | | | | | |
| | γ-Glycidoxypropyltriethoxysilane | | | | | | | |
| | Carnauba wax | | | | | | | |
| | Titania | | | | | | | |
| | Calcium carbonate | | | | | | | |
| Frame retardant | Synthesis Example 1 | 30 | 15 | 50 | | 21 | | |
| | Synthesis Example 2 | | | | 30 | 9 | | |
| | Synthesis Example 3 | | | | | | | |
| | Synthesis Example 4 | | | | | | 30 | 30 |
| | Aluminum hydroxide | | | | | | | |
| | SiO₂ | | | | | | | |
| Items | Evaluating sample | CCL | CCL | CCL | CCL | CCL | CCL | CCL |
| | Frame retardancy (FR property) | V-0 | V-1 | V-0 | V-0 | V-0 | V-0 | V-0 |
| | Glass transition temperature (Tg) | 202 | 204 | 202 | 200 | 201 | 170 | 182 |

TABLE 3

| | | Example 8 | Example 9 | Example 10 | Example 11 | Example 12 |
|---|---|---|---|---|---|---|
| Thermoplastic resin | OH-modified PPE-1 | | | | | |
| | OH-modified PPE-2 | | | | | |
| | Phenoxy resin | | | | 10 | 10 |
| | PES | | | | | |
| | PPE | | | | | |
| | Polyimide resin | | | | | |
| | SPS | | | | | |
| Thermosetting resin | Modified PPE | | | | | |
| | Polyfunctional epoxy resin | | | | 85 | 85 |
| | o-Cresol novolak epoxy resin | | | | | |
| | Bis-A methacrylate | 94 | 94 | | | |
| | TAIC | | | | | |
| | Bismaleimide | | | 78 | | |
| Curing agent/catalyst | DICY | | | | 5 | 5 |
| | Phenol novolak | | | | | |
| | DDM | | | 22 | | |
| | 2E4MZ | | | | 0.1 | 0.1 |
| | CHP | 1 | 1 | | | |
| | PERBUTYL P | | | | | |
| | Triphenylphosphine | | | | | |
| Others | CTBN | 6 | 6 | | 6 | |
| | γ-Glycidoxypropyltriethoxysilane | | | | | |
| | Carnauba wax | | | | | |
| | Titania | | | | | |
| | Calcium carbonate | | | | | |
| Frame retardant | Synthesis Example 1 | 50 | 50 | 15 | | |
| | Synthesis Example 2 | | | | | |
| | Synthesis Example 3 | | | | | |
| | Synthesis Example 4 | | | | 30 | 30 |
| | Aluminum hydroxide | 100 | 100 | | | |
| | SiO₂ | | | | | |
| Items | Evaluating sample | CEM3 | CCL | CCL | RCC | Film |
| | Frame retardancy (FR property) | V-0 | V-0 | V-0 | V-0 | V-0 |
| | Glass transition temperature (Tg) | 174 | 180 | 240 | 168 | 168 |

TABLE 4

| | | Example 13 | Example 14 | Example 15 | Example 16 | Example 17 |
|---|---|---|---|---|---|---|
| Thermoplastic resin | OH-modified PPE-1 | 40 | 40 | 40 | 40 | |
| | OH-modified PPE-2 | | | | | 40 |
| | Phenoxy resin | | | | | |
| | PES | | | | | |
| | PPE | | | | | |
| | Polyimide resin | | | | | |
| | SPS | | | | | |
| Thermosetting resin | Modified PPE | | | | | |
| | Polyfunctional epoxy resin | 58 | 58 | 58 | 58 | |
| | o-Cresol novolak epoxy resin | | | | | |
| | Bis-A methacrylate | | | | | |
| | TAIC | | | | | 60 |
| | Bismaleimide | | | | | |
| Curing agent/catalyst | DICY | | | | | |
| | Phenol novolak | | | | | |
| | DDM | 1 | 1 | 1 | 1 | |
| | 2E4MZ | 0.1 | 0.1 | 0.1 | 0.1 | |
| | CHP | | | | | |
| | PERBUTYL P | | | | | 2.5 |
| | Triphenylphosphine | | | | | |
| Others | CTBN | | | | | |
| | γ-Glycidoxypropyltriethoxysilane | | | | | |
| | Carnauba wax | | | | | |
| | Titania | | | | | |
| | Calcium carbonate | | | | | |
| Frame retardant | Synthesis Example 1 | | | 10 | 10 | 30 |
| | Synthesis Example 2 | | | | | |
| | Synthesis Example 3 | 30 | | 10 | 10 | |
| | Synthesis Example 4 | | 30 | 10 | 10 | |
| | Aluminum hydroxide | | | | 35 | |
| | SiO₂ | | | | | 30 |
| Items | Evaluating sample | CCL | CCL | CCL | CCL | CCL |
| | Frame retardancy (FR property) | V-0 | V-0 | V-0 | V-0 | V-0 |
| | Glass transition temperature (Tg) | 200 | 198 | 203 | 198 | 196 |

TABLE 5

| | | Example 18 | Example 19 | Example 20 | Example 21 | Example 22 |
|---|---|---|---|---|---|---|
| Thermoplastic resin | OH-modified PPE-1 | | | | | |
| | OH-modified PPE-2 | | | | | |
| | Phenoxy resin | | | | | |
| | PES | | | 21 | | |
| | PPE | | 30 | | | |
| | Polyimide resin | | | | | |
| | SPS | | | | | 38 |
| Thermosetting resin | Modified PPE | 70 | | | | |
| | Polyfunctional epoxy resin | | | 50 | | |
| | o-Cresol novolak epoxy resin | | | | 9.4 | |
| | Bis-A methacrylate | | | | | |
| | TAIC | 30 | 70 | 70 | | |
| | Bismaleimide | | | | | |
| Curing agent/catalyst | DICY | | | | | |
| | Phenol novolak | | | 29 | 5.1 | |
| | DDM | | | | | |
| | 2E4MZ | | | 0.08 | | |
| | CHP | | | | | |
| | PERBUTYL P | 2.5 | 3 | | | |
| | Triphenylphosphine | | | | 0.1 | |
| Others | CTBN | | | | | |
| | γ-Glycidoxypropyltriethoxysilane | | | | 0.3 | 0.45 |
| | Carnauba wax | | | | 0.2 | |
| | Titania | | | | | 45 |
| | Calcium carbonate | | | | | 11 |
| Frame retardant | Synthesis Example 1 | 30 | 30 | 15 | | 6 |
| | Synthesis Example 2 | | | | | |
| | Synthesis Example 3 | | | | | |
| | Synthesis Example 4 | | | | 2.4 | |
| | Aluminum hydroxide | | | | | |
| | SiO₂ | | | | 85 | |
| Items | Evaluating sample | CCL | CCL | CCL | Sealing | molding |
| | | | | | material | material |
| | Frame retardancy (FR property) | V-0 | V-0 | V-0 | V-0 | V-0 |
| | Glass transition temperature (Tg) | 230 | 170 | 175 | 193 | 100 |

TABLE 6

| | | Comparative | Comparative | | Comparative | Comparative |
|---|---|---|---|---|---|---|
| | | Example 1 | Example 2 | Comparative Example 3 | Example 4 | Example 5 |
| Thermoplastic resin | OH-modified PPE-1 | 40 | 40 | 40 | 40 | |
| | OH-modified PPE-2 | | | | | |
| | Phenoxy resin | | | | | |
| | PES | | | | | |
| | PPE | | | | | |
| | SPS | | | | | |
| | Polyimide resin | | | | | |
| Thermosetting resin | Modified PPE | | | | | |
| | Polyfunctional epoxy resin | 58 | 58 | 58 | 58 | 94 |
| | o-Cresol novolak epoxy resin | | | | | |
| | Bis-A methacrylate | | | | | |
| | TAIC | | | | | |
| | Bismaleimide | | | | | |
| Curing agent/catalyst | DICY | | | | | 6 |
| | Phenol novolak | | | | | |
| | DDM | 1 | 1 | 1 | 1 | |
| | 2E4MZ | 0.1 | 0.1 | 0.1 | 0.1 | 0.1 |
| | CHP | | | | | |
| | PERBUTYL P | | | | | |
| | Triphenylphosphine | | | | | |
| Others | CTBN | | | | | |
| | γ-Glycidoxypropyltriethoxysilane | | | | | |
| | Carnauba wax | | | | | |
| | Titania | | | | | |
| | Calcium carbonate | | | | | |
| Frame retardant | Compatible type phosphazene | | 24 | | | 24 |
| | Synthesis Example 5 | | | | 30 | |
| | Synthesis Example 1 | | | 230 | | |
| | Aluminum hydroxide | | | | | |
| | SiO₂ | | | | | |
| Items | Evaluating sample | CCL | CCL | No sample was able to | CCL | CCL |
| | | | | be obtained. | | |
| | Frame retardancy (FR property) | Total loss by | V-0 | — | V-2 | V-0 |
| | | burning | | | | |
| | Glass transition temperature (Tg) | 202 | 156 | — | 200 | 130 |

TABLE 7

| | | Comparative | Comparative | Comparative | Comparative | Comparative |
|---|---|---|---|---|---|---|
| | | Example 6 | Example 7 | Example 8 | Example 9 | Example 10 |
| Thermoplastic resin | OH-modified PPE-1 | | | | | |
| | OH-modified PPE-2 | | | | 40 | |
| | Phenoxy resin | | | 10 | | |
| | PES | | | | | |
| | PPE | | | | | |
| | SPS | | | | | |
| | Polyimide resin | | | | | |
| Thermosetting resin | Modified PPE | | | | | 70 |
| | Polyfunctional epoxy resin | | | 85 | | |
| | o-Cresol novolak epoxy resin | | | | | |
| | Bis-A methacrylate | 94 | | | | |
| | TAIC | | | | 60 | 30 |
| | Bismaleimide | | 78 | | | |
| Curing agent/catalyst | DICY | | | 5 | | |
| | Phenol novolak | | | | | |
| | DDM | | 22 | | | |
| | 2E4MZ | | | 0.1 | | |
| | CHP | 1 | | | | |
| | PERBUTYL P | 1 | | | 2.5 | 2.5 |
| | Triphenylphosphine | | | | | |
| Others | CTBN | 6 | | 6 | | |
| | γ-Glycidoxypropyltriethoxysilane | | | | | |
| | Carnauba wax | | | | | |
| | Titania | | | | | |
| | Calcium carbonate | | | | | |
| Frame retardant | Compatible type phosphazene | 24 | 12 | 24 | 24 | 24 |
| | Synthesis Example 5 | | | | | |
| | Synthesis Example 1 | | | | | |
| | Aluminum hydroxide | 100 | | | | |
| | SiO₂ | | | | 30 | |
| Items | Evaluating sample | CEM3 | CCL | RCC | CCL | CCL |
| | Frame retardancy (FR property) | V-0 | V-0 | V-0 | V-0 | V-0 |
| | Glass transition temperature (Tg) | 132 | 218 | 127 | 156 | 189 |

TABLE 8

| | | Comparative | Comparative | Comparative | Comparative |
|---|---|---|---|---|---|
| | | Example 11 | Example 12 | Example 13 | Example 14 |
| Thermoplastic resin | OH-modified PPE-1 | | | | |
| | OH-modified PPE-2 | | | | |
| | Phenoxy resin | | | | |
| | PES | | 21 | | |
| | PPE | 30 | | | |
| | SPS | | | | 44 |
| | Polyimide resin | | | | |
| Thermosetting resin | Modified PPE | | 50 | | |
| | Polyfunctional epoxy resin | | | | |
| | o-Cresol novolak epoxy resin | | | 9.4 | |
| | Bis-A methacrylate | | | | |
| | TAIC | 70 | | | |
| | Bismaleimide | | | | |
| Curing agent/catalyst | DICY | | | | |
| | Phenol novolak | | 29 | 5.1 | |
| | DDM | | | | |
| | 2E4MZ | | 0.08 | | |
| | CHP | | | | |
| | PERBUTYL P | 3 | | | |
| | Triphenylphosphine | | | 0.1 | |
| Others | CTBN | | | | |
| | γ-Glycidoxypropyltriethoxysilane | | | 0.3 | |
| | Carnauba wax | | | 0.2 | |
| | Titania | | | | 45 |
| | Calcium carbonate | | | | 11 |
| Frame retardant | Compatible type phosphazene | 24 | 12 | | |
| | Synthesis Example 5 | | | | |
| | Synthesis Example 1 | | | | |
| | Aluminum hydroxide | | | | |
| | SiO₂ | | | | |
| Items | Evaluating sample | CCL | CCL | Sealing material | molding material |
| | Frame retardancy (FR property) | V-0 | V-0 | V-1 | V-2 |
| | Glass transition temperature (Tg) | 130 | 155 | 193 | 100 |

1. A flame-retardant resin composition, comprising a resin comprising any one or both of a thermosetting resin and a thermoplastic resin, and a cyclophosphazene represented by the following formula (1), wherein the cyclophosphazene compound is incorporated into the resin in an amount of 0.1 to 200 parts by mass based on 100 parts by mass of the resin: 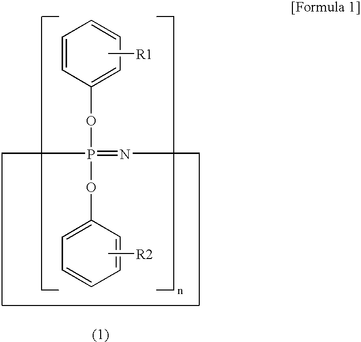
wherein n=3 to 25, one of R1 and R2 is CN, and the other is H, or both thereof are CN, and the percentage of the cyanophenoxy groups in the compound is from 2 to 98% of the total number of the phenoxy groups and the cyanophenoxy groups in the compound.

2. The flame-retardant resin composition according to claim 1, comprising an inorganic filler.

3. The flame-retardant resin composition according to claim 1, wherein the composition comprises one or more resins selected from the thermosetting resins consisting of a group of epoxy resin, radical polymerizable resin, polyimide resin, and modified resins thereof; and thermoplastic resins consisting of a group of polyphenylene ether resin, thermoplastic polyimide resin, polyetherimide resin, poyethersulfone resin, phenoxy resin, and modified resins thereof.

4. A prepreg obtained by impregnating a glass substrate or an organic fiber substrate with a flame-retardant resin composition according to claim 1, and then drying the resultant.

5. A resin sheet obtained by applying a flame-retardant resin composition according to claim 1 on a metal foil surface or a film surface, and then drying the resultant.

6. A molding obtained by forming a flame-retardant resin composition according to claim 1 into a shape.

7. The flame-retardant resin composition according to claim 2, wherein the composition comprises one or more resins selected from the thermosetting resins consisting of a group of epoxy resin, radical polymerizable resin, polyimide resin, and modified resins thereof; and thermoplastic resins consisting of a group of polyphenylene ether resin, thermoplastic polyimide resin, polyetherimide resin, poyethersulfone resin, phenoxy resin, and modified resins thereof.

8. A prepreg obtained by impregnating a glass substrate or an organic fiber substrate with a flame-retardant resin composition according to claim 2, and then drying the resultant.

9. A prepreg obtained by impregnating a glass substrate or an organic fiber substrate with a flame-retardant resin composition according to claim 3, and then drying the resultant.

10. A prepreg obtained by impregnating a glass substrate or an organic fiber substrate with a flame-retardant resin composition according to claim 7, and then drying the resultant.

11. A resin sheet obtained by applying a flame-retardant resin composition according to claim 2 on a metal foil surface or a film surface, and then drying the resultant.

12. A resin sheet obtained by applying a flame-retardant resin composition according to claim 3 on a metal foil surface or a film surface, and then drying the resultant.

13. A resin sheet obtained by applying a flame-retardant resin composition according to claim 7 on a metal foil surface or a film surface, and then drying the resultant.

14. A molding obtained by forming a flame-retardant resin composition according to claim 2 into a shape.

15. A molding obtained by forming a flame-retardant resin composition according to claim 3 into a shape.

16. A molding obtained by forming a flame-retardant resin composition according to claim 7 into a shape.
